(19) United States
(12) Patent Application Publication
(10) Pub. No.: US 2005/0163892 A1
(43) Pub. Date: Jul. 28, 2005

(54) Frozen additive for use with a heated beverage

(76) Inventors: Robert Breslow, Chicago, IL (US); Monica J. Breslow, Chicago, IL (US)

Correspondence Address: Patrick D. Richards;McDermott, Will & Emery, 227 West Monroe, Chicago, IL, 60606-5096, US

(21) Appl. No.: 10/767,002

(22) Filed: Jan. 28, 2004

(51) Int. Cl. A23B 4/00

(52) U.S. Cl. 426/115

(57) ABSTRACT

Disclosed is a frozen additive for use with a heated beverage including a frozen liquid made from substantially the same ingredients as the heated beverage. Further disclosed is a system for cooling a heated beverage including a container holding a heated beverage with a first concentration of ingredients and a frozen additive with a second concentration of ingredients. In the system the second concentration of ingredients is substantially the same as the first concentration of ingredients. Also disclosed is a method of cooling a heated beverage including the steps of: providing a heated beverage having a first concentration of ingredients; providing a frozen additive having a second concentration of ingredients; and combining the heated beverage and the frozen additive to form a beverage having a third concentration of ingredients, wherein the third concentration of ingredients is substantially the same as the first concentration of materials.

### TECHNICAL FIELD

The present subject matter relates to a frozen additive for use with a heated beverage. More specifically, the present subject matter relates to a frozen flavored additive for cooling a heated beverage.

### BACKGROUND

Heated beverages, such as, for example coffee, tea or hot chocolate, were often served at a temperature that was higher than desired by consumers for consumption. In order to avoid discomfort, or even injury, it was often necessary to cool a heated beverage prior to consumption. There were two common procedures for cooling beverages. The first method was to allow the beverage to cool towards the ambient temperature over a period of time. One problem associated with this first method was the length of time required to cool the beverage. The second method was to insert ice cubes into the beverage to rapidly reduce the temperature of the heated beverage. Unfortunately, this second method resulted in dilution of the heated beverage.

### SUMMARY

The present subject matter discloses a frozen additive for use with a heated beverage. The frozen additive may be approximately the same concentration of ingredients as the heated beverage to enable the frozen additive to cool the heated beverage without substantially diluting the heated beverage. Alternatively, the frozen additive may comprise a substantially higher concentration as the heated beverage to give the beverage a concentration boost while cooling. In another embodiment, the frozen additive may utilize different ingredients to alter the flavor or content of the ingredients in the heated beverage as it is cooled. In yet another embodiment, the frozen additives may be packaged with ingredients used to make the heated beverage. The present subject matter further relates to a method of cooling a heated beverage with any of the above-mentioned frozen additives.

### BRIEF DESCRIPTION OF DRAWINGS

FIG. 1 is a perspective view of a frozen additive and a heated beverage.

FIG. 2 is a perspective view of a tray for delivering frozen additives.

FIG. 3 is a flow chart depicting a method of utilizing a frozen additive with a heated beverage

### DETAILED DESCRIPTION

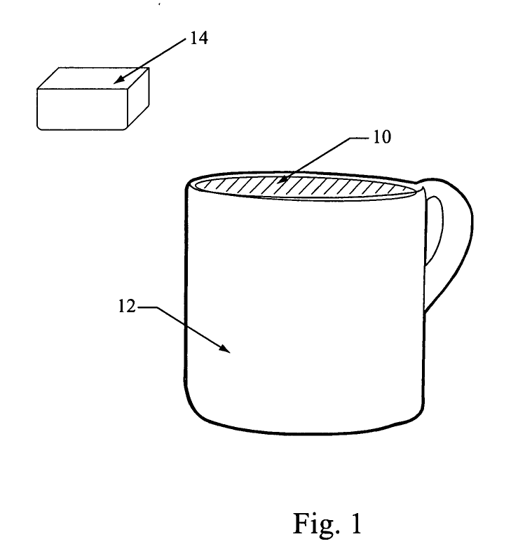

FIG. 1 illustrates a heated beverage 10 in a container 12. The heated beverage 10 shown in FIG. 1 is coffee. However, for purposes of the present subject matter the heated beverage 10 may alternatively be any flavored beverage (i.e., not simply water) that may be consumed at a temperature above the ambient temperature, such as, for example, espresso, latte, cappuccino, mocha, apple cider, hot chocolate, tea, etc.

As commonly occurs when preparing the heated beverage 10 for consumption, the temperature of the heated beverage 10 is often raised above the desired consumption temperature. Raising the temperature of the heated beverage beyond the desired temperature may occur intentionally or unintentionally. It is recognized that the temperature desired for consumption is subjective and, accordingly, may vary from person to person. Therefore, even if the heated beverage 10 is raised to a predetermined temperature, that temperature may exceed the desired temperature for a particular use or consumer. It is further recognized that the desired temperature may fall within a range of temperatures and often does not lend itself to precise calculation.

FIG. 1 further illustrates a frozen additive 14 for use with the heated beverage 10. While the frozen additive 14 depicted in FIG. I is substantially in the form of a cube, any shape that will accomplish the goals of this invention is contemplated. The frozen additive 14 shown in FIG. 1 is a coffee based frozen additive 14 made from substantially the same composition of ingredients as the heated beverage 10. The frozen additive 14 may be combined with the heated beverage 10 to lower the temperature of the heated beverage 14 towards a desired temperature. Unlike using ice cubes to cool the heated beverage 10, use of the frozen additive 14 does not substantially dilute the heated beverage 10 from its initial concentration. In order to maximize the cooling benefits and minimize the dilution of the heated beverage, it may be desirable to prepare the heated beverage 10 and the frozen additive 14 from a single source of ingredients. Depending upon the temperature of the heated beverage 10, one or more of the frozen additives 14 may be added to the heated beverage 10 to bring the temperature of the heated beverage 10 to the desired temperature or into the desired range of temperatures without significantly altering the composition of the heated beverage 10.

While the frozen additive 14 shown in FIG. 1 is frozen coffee, the frozen additive 14 may be made from any composition of ingredients, including any beverage that may be consumed after being heated, such as, for example, espresso, latte, cappuccino, mocha, apple cider, hot chocolate, tea, etc. To maintain the benefit of not diluting or substantially altering the concentration of the heated beverage 10, the frozen additive 14 can be made from approximately the same ingredients as the heated beverage 10. For example, a tea based frozen additive 14 could be mixed with a tea based heated beverage 10. It is recognized that an identical match of ingredients and composition of ingredients is not required to enjoy the benefits of the present invention. For example, it has been determined that combining an espresso based frozen additive 14 with a coffee based heated beverage 10 does not substantially alter the composition of the heated beverage 10. In other words, combining the coffee based heated beverage 10 and the espresso based frozen additive 14 forms a beverage having a concentration of ingredients that is substantially the same as the concentration of ingredients in the initial coffee based heated beverage 10.

Alternatively, the frozen additive 14 may be made from a beverage other than what is used as the heated beverage 10. As a result of using different frozen additive 14, various flavors or ingredients may be added to the heated beverage 10. For example, it may be desirable to combine a flavored frozen additive 14 with a coffee based heated beverage 10, thereby adding flavor to the heated beverage 10.

Additionally, the frozen additive 14 may be produced in varying concentrations to appeal to customers wanting to subtly affect the flavor and/or ingredients of the heated beverage 10 while substantially maintaining the composition of ingredients of the heated beverage 10. For example, a coffee based frozen additive 14 may be produced in “light,” “regular” and “strong” concentrations to enable one to increase or decrease the concentration of caffeine in a coffee based heated beverage 10. For example, a “strong” coffee frozen additive 14 may be used to increase the flavor and/or caffeine concentration in a coffee based heated beverage 10. Additionally, other flavors, vitamins or other ingredients could be incorporated into the frozen additive 14 to be used with the heated beverage 10. For example, vitamin C, zinc, protein, creatine (or other health and exercise related supplements) may be incorporated into a frozen additive 14 to be used with a tea or apple based heated beverage 10 to provide a consumer with certain vitamins or minerals.

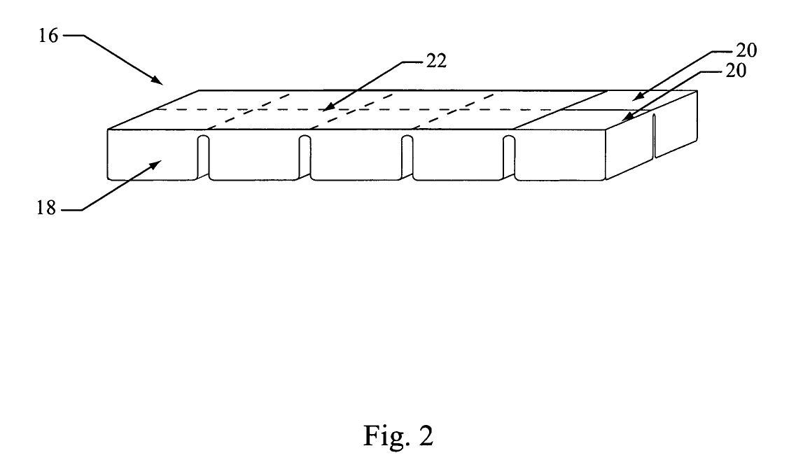

FIG. 2 illustrates a container 16 for storing the frozen additive 14 shown in FIG. 1. The container 16 shown in FIG. 2 is an example of a package for storing a number of frozen additives 14 in a single package. The container 16 shown in FIG. 2 includes a tray portion 18, having a number of serving cups 20 for separating the frozen additives 14 one from the others. The size and shape of the container 16, as well as the number of serving cups 20, may vary as desired. The container 16 also includes a lid portion 22, which may be vacuum sealed to the tray portion 18 to maintain a seal along each of the serving cups 20. For illustrative purposes, the lid portion 22 of the container 16 in FIG. 2 does not cover two of the serving cups 20 to help demonstrate how the unsealed tray portion 18 appears in this embodiment of the container 16. As further shown in FIG. 2, the lid portion 22 may be weakened between the serving cups 20 such that the serving cups 20 may be individually exposed and removed from the container 16 without disturbing the seal of the remaining serving cups 20.

Depending upon the ingredients used, it may be possible to package the frozen additives 14 in the container 16 in an non-refrigerated and non-frozen state. A user of the frozen additives 14 would then place the container 16 or serving cups 20 removed from the container 16 in a freezer prior to use with a heated beverage 10. The serving cups 20 may comprise uniform concentration throughout the container or, alternatively, varying concentration to provide a variety pack.

It may be useful to package some or all of the ingredients used to make the heated beverage 10 in a kit that includes one or more prepackaged servings of the frozen additive 14 in a frozen, or unfrozen, state. For example, ground coffee used to make a the heated beverage 10 may be packaged in a kit with a container 16 comprising serving cups filled with coffee additive. The various frozen additives 14 may be used to tailor the flavor and/or concentration of the ingredients in the heated beverage 10. For example, ground coffee used to make a the heated beverage 10 may be packaged in a kit with coffee based frozen additives 14 of varying strengths to enable various combinations of the heated beverage 10 and the frozen additives 14 to be produced. Accordingly, a decaffeinated coffee based frozen additive 14 could be packaged with ingredients to make a caffeinated coffee based heated beverage 10. The decaffeinated coffee based frozen additive 14 could be used to dilute the strength of the caffeine concentration in the heated beverage 10. In another example, the frozen additives 14 packaged with the ingredients for making the heated beverage 10 may incorporate various flavors, such as vanilla, cocoa, hazelnut, etc. to enable production of heated beverages 10 of varying flavors.

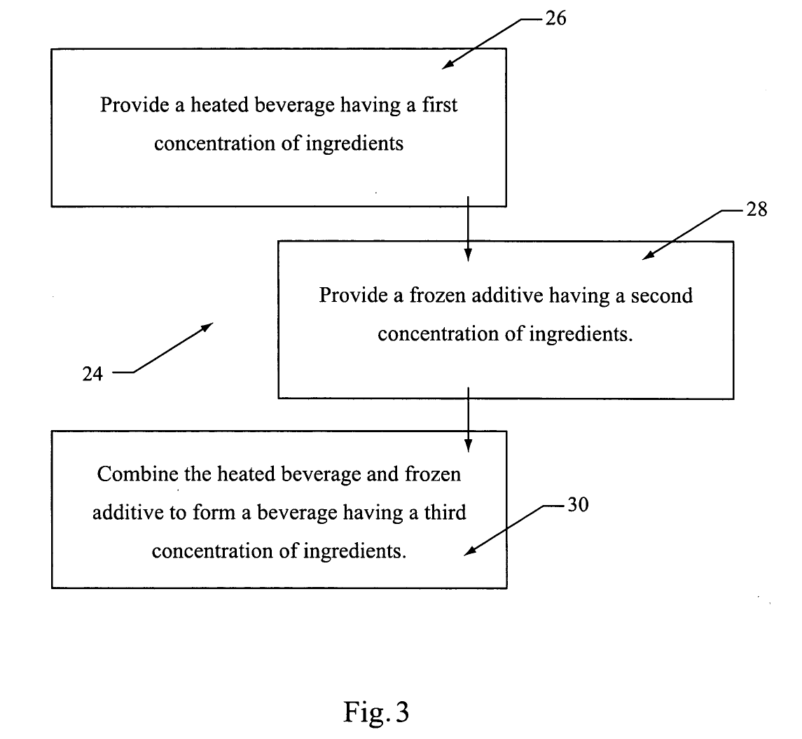

FIG. 3 is a flow chart depicting a method of cooling a heated beverage 24 using the frozen additive 14 and the heated beverage 10 of the present subject matter. As shown in FIG. 3, the method of cooling a heated beverage 24 includes the step of providing a heated beverage 10 having a first concentration of ingredients 26. As further shown in FIG. 3, the method of cooling a heated beverage 24 includes the step of providing a frozen additive 14 having a second concentration of ingredients 28. The second concentration of ingredients may be approximately the same as the first concentration of ingredients to prevent substantial dilution of the heated beverage 10. The method of cooling a heated beverage 24 further includes the step of combining the heated beverage 10 and the frozen additive 14 forming a beverage having a third concentration of ingredients 30. As discussed above, when the frozen additive 14 is approximately the same concentration of ingredients as the heated beverage 10, the resulting concentration of ingredients in the resulting beverage 10 will be substantially the same as the initial concentration of ingredients in the heated beverage 10.

It should be noted that various changes and modifications to the presently preferred embodiments described herein will be apparent to those skilled in the art. Such changes and modifications may be made without departing from the spirit and scope of the present invention and without diminishing its attendant advantages.

1. A frozen additive for use with a heated beverage comprising:
a frozen liquid of a composition substantially the same as the heated beverage.

2. The frozen additive of claim 1 wherein said frozen liquid is frozen coffee.

3. The frozen additive of claim 2 wherein the heated beverage is coffee.

4. The frozen additive of claim 1 wherein said frozen liquid is frozen espresso.

5. The frozen additive of claim 4 wherein said heated beverage is coffee.

6. A system for cooling a heated beverage comprising:
a container;
a heated beverage in said container, said heated beverage having a first concentration of ingredients; and
a frozen additive in said container, said frozen additive having a second concentration of ingredients, wherein said second concentration of ingredients is substantially the same as said first concentration of ingredients.

7. The system of claim 6 wherein said heated beverage is coffee.

8. The system of claim 7 where in said frozen additive is coffee.

9. The system of claim 6 wherein said heated beverage is coffee.

10. The system of claim 9 wherein said frozen additive is espresso.

11. The system of claim 6 wherein said third concentration of ingredients includes a higher concentration of caffeine relative to said first concentration of ingredients.

12. The system of claim 6 wherein said third concentration of ingredients includes a higher concentration of vitamin C relative to said first concentration of ingredients.

13. The system of claim 6 wherein said third concentration of ingredients includes a higher concentration of zinc relative to said first concentration of ingredients.

14. The system of claim 6 wherein said third concentration of ingredients includes a lower concentration of caffeine relative to said first concentration of ingredients.

15. The system of claim 6 wherein said first concentration of ingredients and said second concentration of ingredients are prepared from a common source of ingredients.

16. A method of cooling a heated beverage comprising the steps of:
providing a heated beverage having a first concentration of ingredients;
providing a frozen additive having a second concentration of ingredients; and
combining said heated beverage and said frozen additive to form a beverage having a third concentration of ingredients, wherein said third concentration of ingredients is substantially the same as said first concentration of materials.

17. The method of claim 16 wherein said heated beverage is coffee.

18. The method of claim 17 wherein said frozen additive is frozen coffee.

19. The method of claim 16 wherein said heated beverage is coffee.

20. The method of claim 19 wherein said heated beverage is espresso.
